(19) United States
(12) Patent Application Publication
(10) Pub. No.: US 2014/0364981 A1
(43) Pub. Date: Dec. 11, 2014

(54) Tablet Based Score Tracking System and Method for Equestrian Judging

(71) Applicants: Matthew Scott Hofstetter, Ocala, FL (US); Thomas M. Miller, Los Altos, CA (US)

(72) Inventors: Matthew Scott Hofstetter, Ocala, FL (US); Thomas M. Miller, Los Altos, CA (US)

(21) Appl. No.: 14/299,307

(22) Filed: Jun. 9, 2014

Related U.S. Application Data
(60) Provisional application No. 61/832,473, filed on Jun. 7, 2013.

(51) Int. Cl. A63F 11/00; G07F 17/32

(52) U.S. Cl. CPC A63F 11/0051; G07F 17/3225; A63F 2011/0058
USPC 700/92

(57) ABSTRACT

A computer-based score tracking system and method that may be used in equestrian judging. The system includes a judge portal, an office portal, an in gate portal and a spectator portal for accessing a computer based server. Mobile computing devices interact with the computer based server to provide real-time updates to scoring and judge comments to spectators. The system allows judges to use customized hand written symbols, letters, and numbers to identify a particular result, while maintaining an organized and numerical ranking system based upon aggregated totals. Additionally, the system allows for tracking of participants to assist in providing accurate judging and location of participants. System is adapted to receive a finalized score card and send final results to office personnel.

### CROSS-REFERENCE TO RELATED APPLICATIONS

This nonprovisional application is a continuation of and claims priority to provisional application No. 61/832,473, entitled “Tablet Based Score Tracking System and Method for Equestrian Judging”, filed Jun. 7, 2013 by the same inventor, the entirety of which is incorporated herein by reference.

### BACKGROUND OF THE INVENTION

1. Field of the Invention

This invention relates to a computer implemented score tracking system and method. More specifically, it relates to a score tracking system and method that utilizes and identifies customized score tracking.

2. Brief Description of the Related Art

Scoring of sporting events can greatly differ between the types of sporting events. Some sporting events utilize an objective point based system where the ranking are determined by how many times a point has been scored. For example, basketball tracks the amount of times a basketball has gone into the hoop. A winner is generally determined by the side that put the bail through the hoop the most amount of times. Other sporting events use a more subjective system and based upon one or more judges. An example of this type of scoring is often seen in equestrian events, such as show jumping, dressage and hunters.

Subjective sporting events determine a winner based upon an accumulated score of one or more judges. Each judge may have a unique way of determining a point value system or way of representing the points achieved by a particular individual. The symbols, numbers, and letters used sometimes equate to a unique code that can be interpreted by only that judge. This can mike the process very arduous for the judges, the audience, and the participants.

For example, an equestrian judge, making a determination for a hunter show, will often use short hand or symbols to indicate a particular result, detail, or specifics about an individual and the horse. Every mark has a particular meaning to a specific judge, but may be completely unreadable to another judge. Additionally, the judges use paper to draw and write the results on paper. This can lead to confusion when tallying up the final scores, determining who the score belongs to, and general organization of the results in a tangible fashion.

There exists a need for a score tracking system and method that allows a user to maintain the flexibility awarded written notes, while organizing the information stored. Such a system should also allow for tracking of individuals throughout a competition. Finally, there exists a need for a system that provides easy transmittal, tracking and aggregation of judging results. However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF DESCRIPTION OF THE DRAWINGS

For a fuller understanding of the invention, reference should be made to the following detailed description, taken in connection with the accompanying drawings, in which:

FIG. 1 is an illustration of the event information that may be displayed to a judge in accordance with a preferred embodiment of the present invention;

FIG. 2 depicts an event score card in accordance with a preferred embodiment of the present invention;

FIG. 3 is a depiction of the final standings of a judged competition accordance with a preferred embodiment of the present invention;

FIG. 4 depicts the submission screen for sending final results in accordance with a preferred embodiment of the present invention;

FIG. 5 depicts an approved score card with judge signature in accordance with a preferred embodiment of the present invention;

FIG. 6 depicts an exemplary diagram illustrating the interaction between components of the system in accordance with a preferred embodiment of the present invention;

FIG. 7 is a flowchart of the method of logging a judge into the judge portal in accordance with a preferred embodiment of the present invention;

FIG. 8 is a flowchart of the method of interaction between judge portal, office portal and computer based server in accordance with a preferred embodiment of the present invention.

### DETAILED DESCRIPTION OF THE PREFERRED EMBODIMENT

In the following detailed description of the preferred embodiment, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

Currently, sporting events that use subjective judging often utilize paper to write “short hand” notes that are later interpreted by the same judge to come up with a point based score, usually out of one-hundred (100). Depending upon the type of class, the judge determines the final placings by considering the point based score as well as other considerations. The class results consisting of “short hand” notes, point scores, and the final placings are written down on paper score cards. The score cards are delivered to an intermediary who transports the score cards to a show office. Between multiple rounds and classes, the paper score cards can become disorganized and misinterpreted. Judges will often have to look down in order to write down a score and may miss crucial aspects of the competition. In addition, spectators will often have to wait until the end of the competition for reading of the results, instead of being provided real time feedback. These issues have become particularly prevalent in equestrian judging, where meticulous attention to detail is required.

The present system and method enhances the efficiency and reliability of judging equestrian events, and other sporting events. Specifically, the present invention provides features that 1) optimize the time that a judge has to observe the horse and rider, 2) reduce judging errors and allows the judge to correct scoring problems while still having time to observe the horse and rider and 3) improve communication between personnel working together at a horse show (judges, in-gate personal, announcers, office personal). The system and method includes several novel components that may be used independently of, or in conjunction with, each other.

The method and system includes having a judge portal for accessing a computer based server. Judge portal may be accessed by visiting a webpage on a mobile computing device or opening an application on a mobile computing device. In a preferred embodiment, the mobile computing device is a tablet, laptop computer, or cellular device with an integrated touch screen. The integrated touch screen is preferred because it allows the adaptability for a judge to track utilizing their own shorthand, symbols, and write as they would on a piece of paper. It is understood that other graphical interfaces, such as those known in the art, may be used.

After visiting the webpage or application, judge will be prompted to enter a unique identifier. Information used will uniquely identify a judge and allow access to documents, files, pre-set preferences, competition schedule and other information relevant to the identified judge. Unique identifier may be any combination of words, numbers or symbols that uniquely identifies a judge. A password or additional predetermined questions may be included to provide additional security and verification of judge's identity. Judge may also set up an electronic mobile device to automatically log judge into application. Judge may also proceed as an unregistered user as a one-time event.

Computer based server is adapted to receive a unique judge identifier. Unique judge identifier may be any combination of words, symbols or numbers that uniquely identify a judge. Unique identifier is compared to a stored list of unique judge identifiers. A determination is then made as to whether the judge is registered. If the judge is registered, i.e. the unique identifier matches a unique registered user, the judge is associated with the registered user. Additionally security questions, such as passwords may be asked as an extra layer of security. If the unique judge identifier does not match a registered user, the system will prompt the judge to create an account.

Each judge account may contain pre-set event information that may be selected by judge. In one embodiment, a judge may choose from a list of event information upon logging into the computer based server. In another embodiment, the system is adapted to automatically enter event information based upon a pre-set event occurring. Pre-set event may include, but is not limited to, a scheduled time and date, GPS location of the mobile electronic device, and connecting to a specific wireless network. In another embodiment, judge may manually enter event information which may be stored on the computer based server or mobile electronic device.

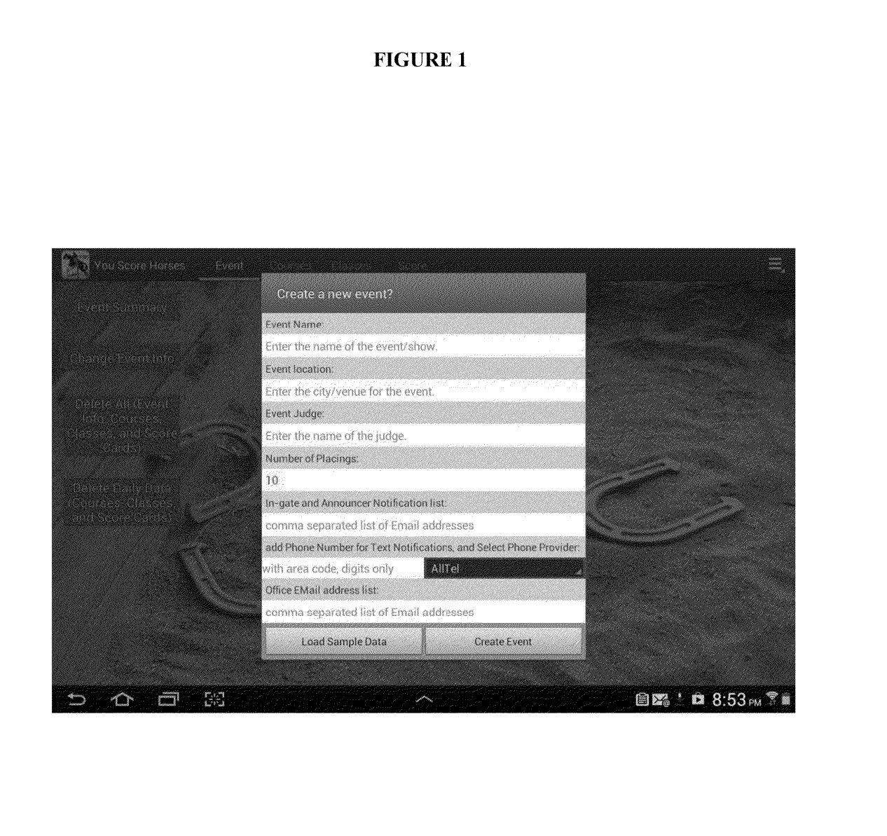

FIG. 1 substantially illustrates how the event information may be displayed to a judge. Event information may include, but is not limited to, event name, event location, event judge, number of placings, in-gate and announcer notification list, office notification list. Judges may also have menu options, illustrated along the left of the screen in FIG. 1 that can be used for navigating events associated with the judge. The menu options may include, but are not limited to, event summaries, edit existing event information, and remove specific information.

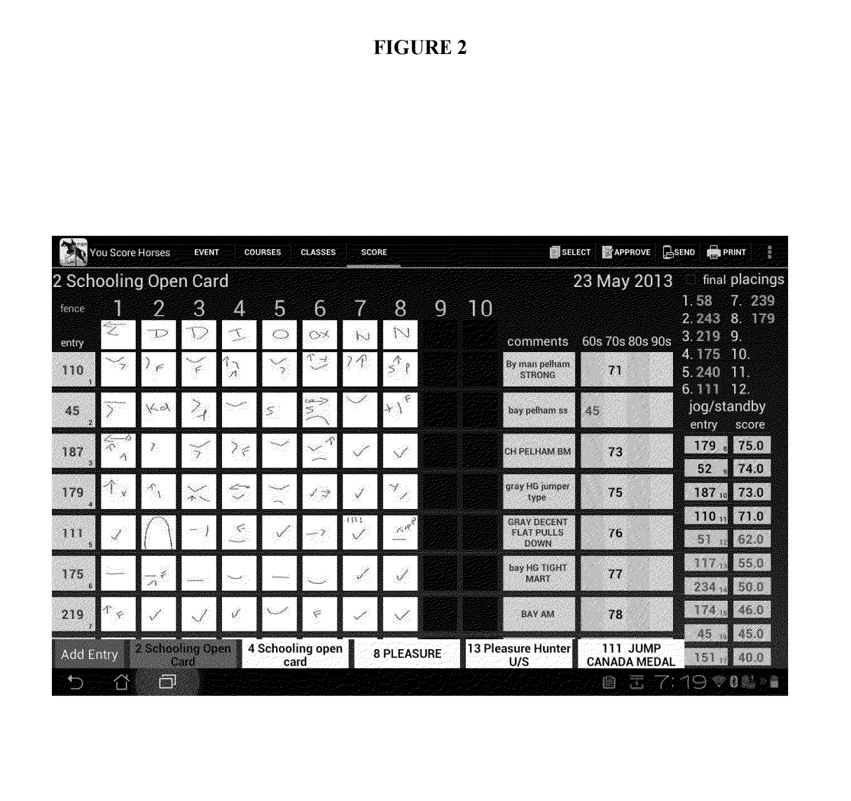

Once an event is created, one or more scoring cards may be entered with a plurality of entries under each scoring card. In a preferred embodiment, the scoring cards and plurality of entries are automatically populated specific to a judge. The computer based server receives a judge identification, an event information and a plurality of scoring cards that are relevant, to a judge. The server associated the judge with the one or more events and event details. Event details includes scoring cards, entries, and other information relevant to a judge. Once a judge has logged into the system, the computer based server sends the event details relevant to the logged in judge to the mobile computing device. In an alternative embodiment, a judge may manually enter information relevant to the event details. Event details may be changed through computer based server by an event director or other individual available to log in through an event director portal. FIG. 2 depicts an event score card in accordance with a preferred embodiment of the present invention.

Each score card contains an entry section that is used to identify a particular participant. While numbers are used in the present example, it is foreseeable that any identifier may be used that uniquely identifies a particular participant. Each entry has a set number of particular objectives that a participant is judged on. The objectives are illustrated across the top and numbered 1-10, although any number or identifying markings may be used. The present example demonstrates how the system works for an equestrian event; however, it is foreseeable that the system may be used for various sporting events that require judging.

A plurality of boxes, as illustrated in FIG. 2, are adapted to receive short hand notes from a judge during a competition. In the present example, the type of obstacle is written across the top, with notes on a horse and riders performance written across the columns. A judge may simply click on the appropriate box and enter the short hand writing. In a preferred embodiment, the short hand writing is entered into each specific field through use of a tablet device with touch screen. After short hand notes are entered for an obstacle, the system saves the notes and automatically presents another box to enter the notes for the next obstacle. This allows the judge to get the same overall feel as traditional note taking.

As illustrated in FIG. 2, each judge has a variety of ways to take notes while judging an event. Judges may use symbols, numbers, letters or any combination thereof, to create marks the judge can use for determining a final score. The system allows a judge to write out each note as they are viewing the event. This results in a score sheet that would be similar to that of a written score sheet. To make note taking even easier, the system allows a judge to store “short cut” keys in order to quickly insert a note that has been used before. The short cut keys are completely customizable by the judge and may be accessed by various actions on the part of the judge. The various actions may include, but are not limited to, keyboard buttons, verbal cues, and gestures on a touch screen. The system is adapted to associate a particular short cut key with a symbol that has been pre-recorded by the judge. Upon a determination that the received judge input short key matches a pre-determined symbol, the system will automatically input the mark into the appropriate box. For example, a judge may decide to make a check mark to indicate a perfectly performed jump. While the judge may manually write a check mark symbol in the appropriate box, the judge may use a number one numerical key to input an image of his drawn check mark. The number one numerical key and check mark image were pre-set by the judge. Specific points may also be associated with the pre-entered symbols. In this manner the system may create a standardized scoring system to ensure consistent ratings between marks. The judge can always go in and alter specific point association based upon factors that may not be easily standardized, such as dress and presentation.

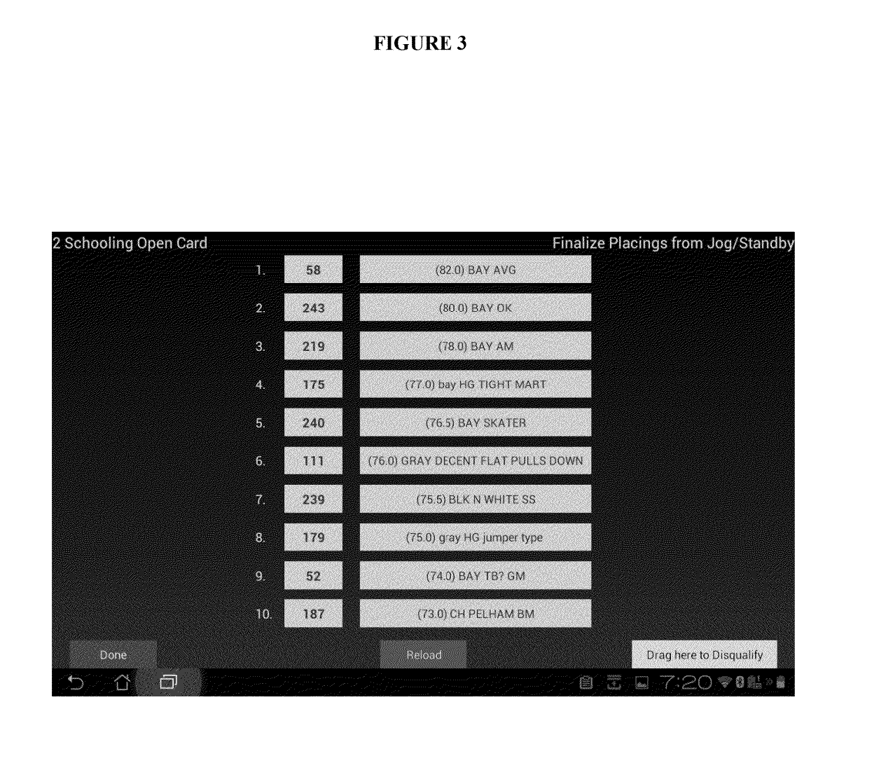

The system also provides real time tracking of overall scores and rankings As the judge enters and allocates points, the placement and overall scores are received and updated by the computer based server. This provides real-time feedback to participants and spectators. FIG. 3 illustrates a sample listing of the final placing of competitors.

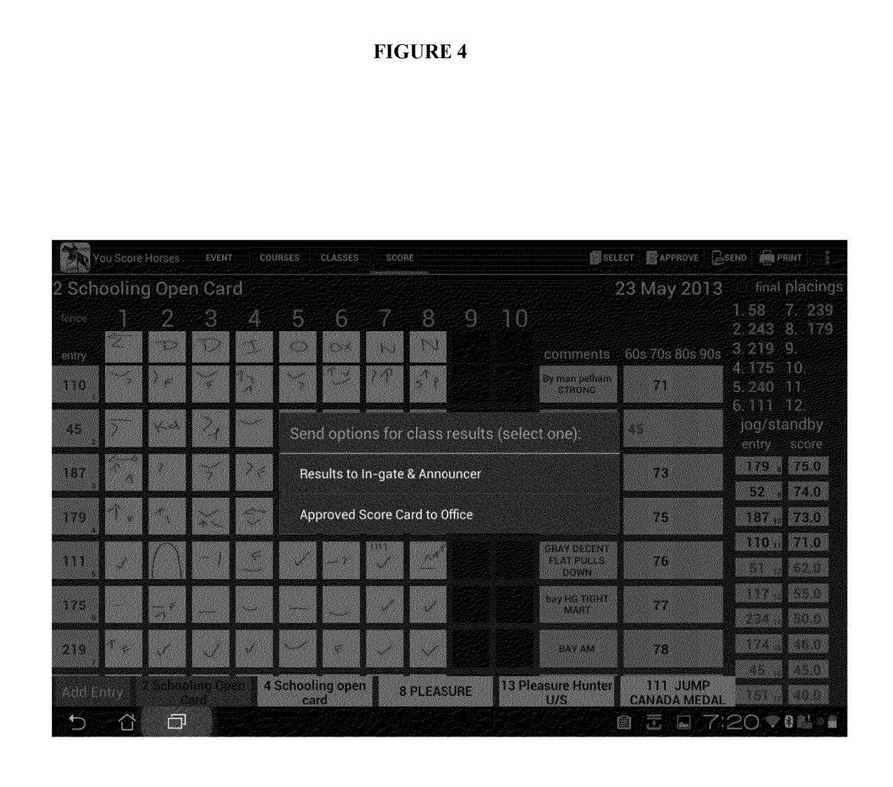

When interim or final results have been determined, traditional methods involved a tallying up of points and communicating your interim or final placing list to in-gate, announcer, or to the show office. The process is often long and does not allow participants or spectators to view the scoring and point allocation. The present system provides a method of instantly transmitting the interim and finalized scores to an in-gate & announcer or to the office. FIG. 4 illustrates the sending screen for transmitting the scores to a particular individual. The results may be transmitted to another mobile electronic device, such as a cellular phone, tablet, laptop computer, or other computing device through the server. Alternatively the system may be adapted to transmit the results through e-mail, text, or SMS messaging. Contact information of Office or in gate announcer may be stored and associated with the event on the computer based server or manually entered.

The entirety of the system involves several unique aspects that work in conjunction to present a workflow-based software system for tracking scores of sporting events. In particular, several novel aspects are discussed in additional detail below.

Electronically Send Score Results to Show Personal that are Received as Text Messages.

The system provides an electronic message that contains the current list of highest scored entries which is received as a text message by horse show personal. Once a match is completed a judge may edit and re-arrange scoring and placement based upon tracked scores. This information may be tracked through a computer based server to provide real-time feedback or provided only upon approval of the judge. In either case, a computer based server receives the final score placement as indicated by the judge. If there are a plurality of judges, the system may determine a finalized score by averaging each judge's total. Averaged score may then be sent to a display board or to personnel working the horse show. In an alternative embodiment, the finalized scores may automatically be converted to an SMTP, SMS or text message format. The results are then transmitted to a mobile computing device that is adapted to receive a plurality of scores. The scores are stored on the electronic computing device or a computer based server.

In traditional equestrian shows, the judge uses a walkie-talkie to verbally communicate the list of entries and class results to other horse show personal. There are usually other judges and rings being used for judging at a horse show so a judge has to wait until the channel is clear before using it. A judge reads a list of entries which needs to be written down by other show personal which is time consuming and sometimes results in errors which causes delays and inaccurate results. The present invention provides nearly instant, faster results received by show personal, eliminates transmission errors.

Open/Close Multiple Classes in One Operation.

The system provides seamless transition between classes and score cards. Judge may easily open/close classes based upon choosing to select (check) or unselect (uncheck) a particular class. Traditionally, a judge would have to manage up to five open classes and would have to maintain paper score cards for each open class. Entries can enter the ring associated with any class and the paper score card must be available for the judge to score fences and jumps. Natural events such as a gust of wind can often disrupt the process because the judge will need to find the paper score card and will miss the horse jumping because the entry continues through the course whether or not the judge is observing. The present system allows the judge to instantly open/close classes in one step on the judge does not need to manage paper score cards.

In another embodiment, the opening and closing of classes may be automatically determined by the computer based server. In this embodiment, the server tracks which events are opened/closed based upon pre-determined tracking information. Pre-determined tracking information may include, but is not limited to, time, scores received by judges, information entered by show personnel, and tracking of contestants.

Select an Open Class.

System provides a quick access bar that contains a button for each open class. This is substantially illustrated in FIG. 2. A judge selects the class by touching the classes quick access button. Previously, a judge needed to quickly locate the class for the entry that is entering the ring. Since there can be up to five classes and multiple pages per class this is a significant amount of paper that needs to be available so that the judge is ready to score the horse. During an event, the transitions may occur at a quick pace. The present system allows a judge to quickly select a class and be instantly prepared for scoring entries in that class by simply clicking on the classes quick access button.

Visually Represent Ordered List of Highest-Scored Entries (i.e. Jog Order).

When a judge enters a numeric score for an entry, the system inserts the entry in an ordered list that is visible on the display. The judge can instantly see where the entry ranks with other entries to give the judge visual feedback on how the scores are assigned for the entries in the class. An example of the visual feedback is illustrated in FIG. 2 along the right column. Traditionally, a judge would have to maintain a list of the scores assigned to entries in a class and erases entries and draws arrows to show highest-ordered entries.

The present system allows the judge to instantly see the list of highest-scored entries and can refer to this list before entering a score in order to reduce very close scores/ties. The system provides real-time feedback so that the judge can be aware of overall placement.

Show Entries Judging Results by Clicking on Entries Jog Order Position.

The system stores the entries for each job order. This allows a judge to click on an entry in the jog order list to highlight the judging results for the selected entry.

Currently, when a judge assigns a numeric score to an entry the judge may want to review previously-scored entries that have a score close to the score the judge is considering for the entry being judged. In a class where there are many (50 or more) entries, locating the entries on paper score cards requires scanning one of more pages of the paper score cards to find scores in the range that the judge is considering. This is time-consuming and entries can easily be missed.

The system allows a judge to instantly look at the system maintained jog order and click on entries that the judge wants to review before assigning a score—this helps a judge assign the correct score to the entry. System may be fully searchable based upon notes and comments made about a particularly entry. This allows a judge to go back to particular notes and comments that may be relevant to a final determination.

Abstract an Equestrian Course into Visual Symbols on a Score Card.

System may display a visual representation of an equestrian course on the scoring screen. Each fence or jump is represented by a graphic symbol by a judge, e. g. via a drawing pad. The same course and symbols can be used for any class that uses the same course. Computer based server may also pre-load track data onto the mobile computing device associated with a particular event. Track data may include photos of the particular jumps, distance, and difficulty. In addition, a judge may set particular images, symbols, or drawings to be associated with a particular course. The system will populate the course based upon the judges drawings.

Traditionally, a judge commonly writes course symbols on paper score cards. The symbols have to be entered on each score card page and on each class using the same course. This can become a lengthy task. The present system helps the judge know what the rider is supposed to do at the fence/jump. Once the judge enters the course into the program it can be used for all other classes using the same course.

Visually Rank Horses in C class by Interactive Drag and Drop Gestures.

Some classes score entries at the same time with other horses in a class. The may be in addition or without any numeric scores having been assigned to entries. By pressing a button the system provides a visual display of each entry in a class. As a judge observes the all of the entries in the ring the judge ranks an entry by pressing and dragging the entry to its desired position. When the desired order is achieved the judge presses the “Done” button and the entry order becomes the final placings as shown on the score card.

Traditionally, a judge writes down all of the entries and draws arrows on paper to reflect the desired order. As the entries perform the judge's instructions the judge erases or crosses out the arrows to reflect new order or sometimes re--writes the entry list using the new order.

With the present system the judge can instantly move the entries to desired position, and graphically see the new order. This greatly simplifies the scoring process and reduces errors.

Display Previously Entered Judging Comments for an Entry Whenever the Judge Scores the Entry in Subsequent Classes.

The system allows a judge to enter descriptive information regarding the horse/rider in order to help the judge remember the entry when seen again in other classes. When the entry is judged in another class the application displays the descriptive information previously entered. The entered information may be fully searchable. Additionally, the judge may take a photograph of the participant and associate it with a particular entry to further identify which participant is currently involved.

The system may also automatically select an entry based upon the current participant. In this embodiment, the server receives an indication that a particular participant is moving from an inactive (i.e. not presently competing) to active (i.e. competing or about to start competing). The server will then send the information to the judge's mobile computing device and select the active entry. The system may be further adapted to receive a plurality of data points used to indicate where a participant is along the course. Thus, the mobile computing device will automatically open up the appropriate box for the judge to enter notes based upon where the server indicates a particular participant is located.

Previously, a judge writes down the same descriptive information every time the judge scores the same entry in different classes. The present system save times, easier for the judge to remember the entry from a prior class.

Move Entries Judging Results to Another Class.

A judge can move an entry and all of the scoring information to another class by long-pressing the entry number then selecting the class in which to move the entry and scoring information. This is used when an entry has been placed into the wrong class perhaps due to an announcer error.

Previously, when a judge realizes that the entry has been placed into the wrong class, the judge typically crosses out the entry and scoring information from a paper score card and copies the entry and all of the associated scoring information over to the correct score card. This takes time and distracts the judge from observing the horse and rider. Also the show office is often not comfortable with receiving score cards with entries crossed off since they use this information for billing and accounting purposes. The advantage of the present system is that a judge can instantly move the entries to the correct class while continuing to observe the horse/rider.

Visually Represent Fence/Jump Results.

A judge can draw customized jump results on a drawing pad using a finger, touchpad, or stylus. When finished entering the symbol the symbol is saved and the program clears the pad so the judge can enter the next jump results. The program also allows the Judge to erase the pad to start again. The application places these fence results on electronic score cards. The electronic score cards may be saved to a computer based server and used to automatically update a scoreboard to provide real time feedback.

Currently, a judge must draw jump results in small areas of a paper score card. The judge has to erase or cross out the symbol in order to enter another symbol for the same jump. The present system only allows the fence symbols to be entered for the selected entry so the judge does not need to locate the correct place to enter the symbol like on paper score cards.

Quick Reference Symbols.

System may be customized to allow a judge to use short keys to represent a particular symbol. For example, a judge keeps a finger over the “enter” key and simply presses it to enter a good fence symbol so the judge does not need to look away from the horse/rider to enter good jump symbols.

Previously, a judge would have to draw a symbol on a paper score card for each and every fence. This requires the judge to look away from the horse/rider, locate the entry and the fence and draw the symbol.

The present invention takes advantage of the fact that the majority of entered symbols are good fence symbols the judge is able to continue to observe the horse/rider and only needs to take special action to indicate exceptional results at a fence.

Provide an Electronic Version of an Approved Score Card.

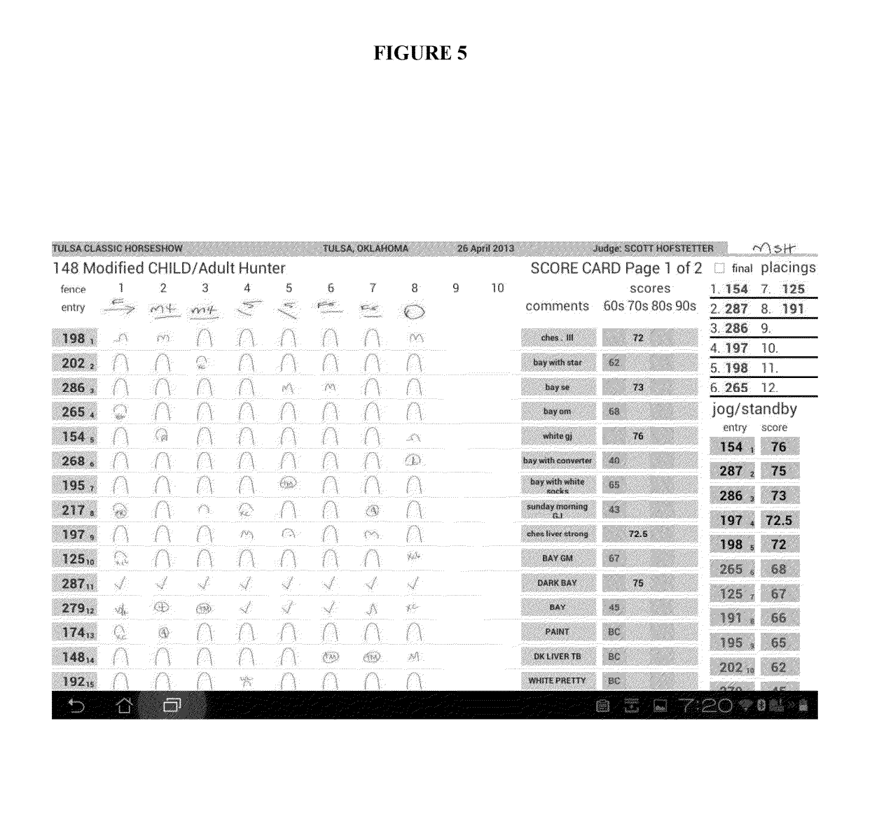

When a judge has completed judging a class, the judge presses a button that solicits an electronic signature from the judge. The program includes the signature on an electronic version of an approved score card. The score card can be emailed, sent by SMS messaging, text messaging and optionally printed at the show office. Verification of the judge's signature authenticates the score card. FIG. 5 is an example of an approved score card with judge signature in accordance with a preferred embodiment of the present invention.

Previously, the judge had to sign a completed paper score card and hand the approved card to a person who collects score cards and carries them to the show office. The present invention provides faster results to the office and also more reliability since the electronic score card is maintained on servers so there is little risk of losing the only record of the results as with a paper score card.

Send Score Card Results to Other Horse Show applications & Internet Servers.

The application provides computer-readable score card results and sends them to applications that are typically used in horse shows. This eliminates the steps to manually enter the entry list and score card results from paper score cards. It also provides the capability for providing real-time feedback for score results.

Previously, horse show office personal had to manually enter the list of entries from paper score cards into billing applications so riders can be charged for the class and personal also had to manually enter the placings from paper score cards that generates the ribbons and class prizes.

The present system allows the judge to complete judging the class, the results can be instantly sent to horse show applications so results can be processed, displayed on show score boards, made available to people in stands with Internet access, etc.

Import Horse Show Information from Published Web Sites.

When a judge selects the text of the class schedule on a web page, email, or PDF file, the system creates classes that include a class number and a class name. This class information in imported into the program. Thus, a judge may use existing information to customize the display and interaction of the system. Traditionally, the judge has to manually enter all of the class information into the program before the classes are judged. The present invention saves time required to manually enter the class information.

Derive Class Behavior Based Upon Class Names and Formats.

There are many types of classes that have different judging processes. The system processes the published format, class numbers, and class names to derive and assign a class type to each class as well as establish relationships between different classes (i.e. an associated class). In a preferred embodiment, the system will automatically process and assign relationships and class types based upon event details. A judge may also enter specific information that tagged a particular entry as belonging to a specified class. The system will read the tag and automatically place the entry within the class type.

Before the present invention the judge needed to manually determine the type and related classes and manually process it. The process of deriving class types greatly simplifies the set up process.

Apply Specialized Processes Based Upon Class Types.

The system applies specialized logic to a class depending upon its class type and its relationship to other classes. Some examples of this specialized logic is 1) adds the results of two classes together, detects and notifies a judge of a tie so a score can be revised, determine the placings based upon combined score (e.g. Classic classes); 2) considers special scoring attributes such as collecting bonus points for jumping higher option jumps or adding points for more efficient turns between jumps and adding them to final scores (Derby Hunter Classes); 3) populates the entries from the entries in another (associated) class (e.g. Under Saddle classes); and 4) in the case of very large classes the program can easily split the top-scored horses from the jog order and form 16 placings/ribbons instead of the typical 8 (e.g. California Split). These processes occur automatically depending on specific information received by the computer based server or mobile electronic device.

Prior to the present invention the judge had to handle the specialized class logic by manually adding scores from different classes, manually adding entries from other classes, manually detect tie scores, etc. By applying specialized handling for classes such as processing/adding scores from related classes is more efficient and much more reliable. Eliminates incorrect scores due to arithmetic errors.

In-Gate Entry Tracking

The present system also includes a way of tracking an identified participant or rider. A rider is given a wrist tag that is scanned by an in-gate person using an “In-gate Assistant” portal when the horse/rider enters the judging ring. The application then electronically notifies the judging application of the entry number and class which causes the judging program to select the correct class, enter the entry number, and prepare the display for receiving judging results. The information may be received by the computer based server. The server will then identify which judges are currently participating in judging the particular event. Each judge that is identified as judging the event will receive an automatic entry of data relevant to the horse/rider. This information may include, but is not limited to, name of participant, age, type of event, and entry number.

Additionally, the wrist band can be used to track the participant throughout the course. In this embodiment, the system will automatically highlight the next item for the judge to review. For example, in an equestrian jumping event, the system will automatically determine which jump is coming up next for the judge to examine based upon location of the participant.

Traditionally, the judge had to listen over the communication system for the entry number and class for the horse entering the ring. If the judge didn't hear the information then the judge had to wait to observe the entry's back number to know the entry being judged and then enter it into the program or on the paper score card. The present system reduces errors from entering the incorrect entry number or entering it into the incorrect class.

In-Gate Jog Order Tracking

The judging system notifies the “In-gate Assistant” portal of any changes to the jog order. The “In-gate Assistant” application displays the judges jog order list of entries for each class being judged. This makes it easier for the in-gate personal to know which entries to keep close to the judging ring and which entries do not need to remain.

Previously, the in-gate personal would need to continually get updates from the judge on the current jog order using walkie-talkies. The present system simplifies the communication process between the in-gate personal and the judges and is faster and much more reliable.

Create Visual Fence and Jump Results by Speech Input

When an entry is being judged, the judge speaks commands that are recognized by the application which enters the appropriate fence symbols. The vocabulary and associated symbols can be customized by the judge. This allows the judge to maintain eye contact with the horse/rider throughout the course which greatly increases the accuracy of the judging process.

Real Time Tracking of Judging Results for Score Boards and Other Applications & Devices.

When the judge enters the judging results into the application the application sends the results to an electronic score board monitoring device which displays the entry's score and the current placing order. So when the horse leaves the ring the spectators can see the results immediately.

Traditionally, spectators at a horse show generally only see the placings or final order of the when all of the entrys in a class have been scored. This allows spectators to closely follow the class results.

Spectator Tracking of Detailed Judging Results.

The system may also allow for a spectator portal. Spectators can log into the computer based server and view real time judging results and comments. As the judge enters the judging results the application sends the results to an application in spectators' phone and tablet devices that display the results in real-time.

Before spectators at a horse show could generally only see the placings or final order of the entrys. The detailed judging results such as the fence jump results are not made available. This allows spectators or judges-in-training to closely follow the judging process and gives them special insight into how the judge evaluated the horse and rider.

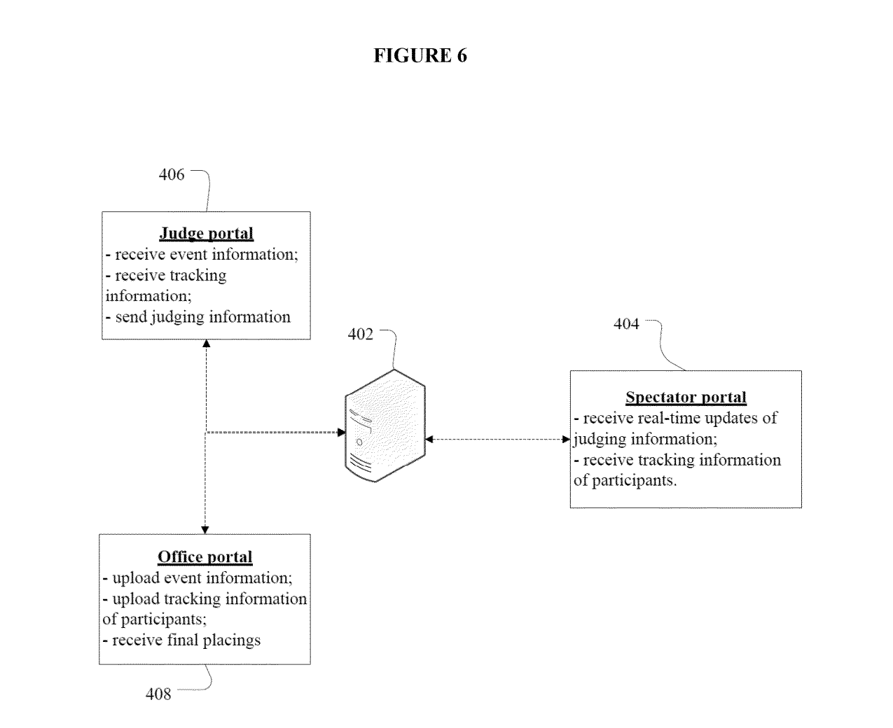

FIG. 6 is an illustration of the components of the scoring system in accordance with a preferred embodiment of the present invention. While the example provided illustrates interaction across a computer based server, it is foreseeable that the various portals may interact directly through each mobile electronic device. The system includes a computer based server 402 adapted to receive various information relating to a sporting event. A mobile electronic device is used to log into the various portal systems 404, 406, 408. Each portal has its own log in requirements that allow a mobile electronic device to interact with the system in a different way. The Office portal 406 allows uploading of event information and details that may be relevant to spectators and judges. The computer based server 402 may be pre-set with filters to automatically remove event information that will not be shared with spectators 404. In an alternative embodiment, Office 408 may determine what information is sent to spectators each time. Office portal 408 also allows uploading of tracking information for participants. Participants may be tracked through a wrist band, event tag, or other tracking device to indicate where the participant is in relation to the course. Finally, Office portal 408 is adapted to receive final standing from the judge portal 406 for publication and announcement. Judge portal 406 is adapted to receive event information and tracking information from Office portal 408. Communication between Office portal 408 and Judge portal 406 may occur directly or through the computer based server 402. Judge portal 406 is also adapted to transmit judging information and results. Spectator portal 404 allows spectators to receive real-time updates of judging information and results as well as receive tracking information of participants. This gives spectators unprecedented ability to interact throughout a competition. There may be an additional In-Gate portal (not shown) that interacts with the computer based server by providing gate information.

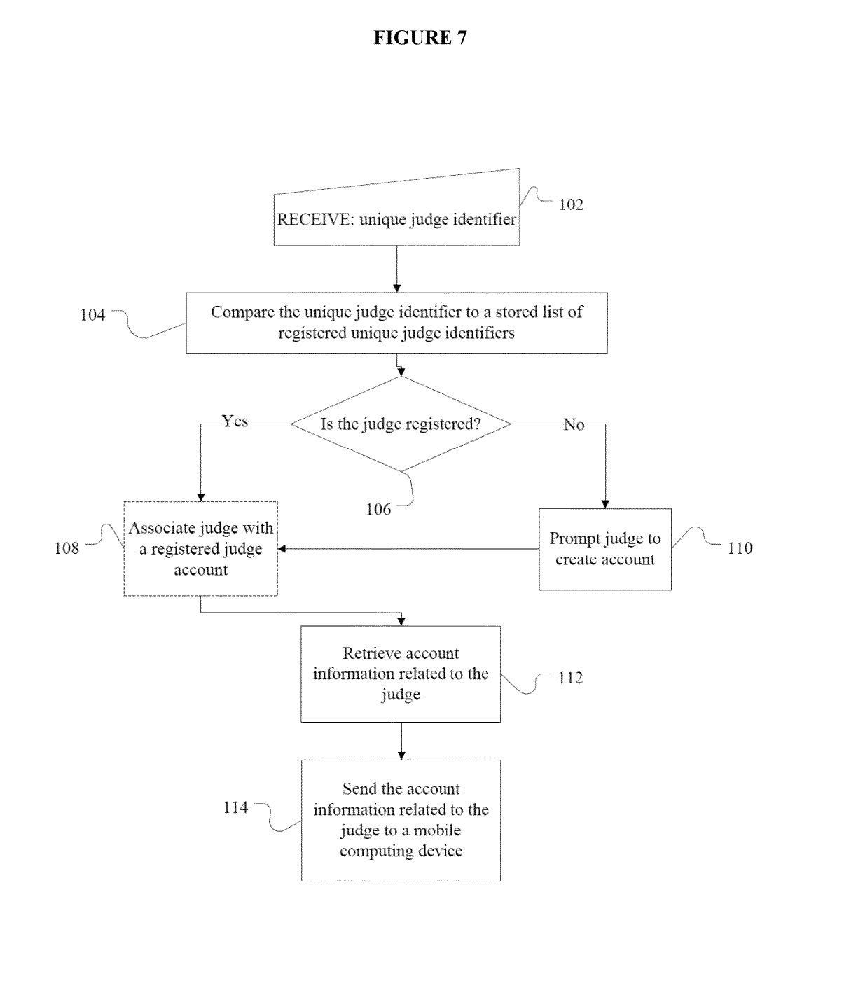

FIG. 7 illustrates a flowchart showing the method of identifying a mobile electronic device with a registered judge. The computer based server receives a unique identifier to associate the individual with a registered account 102. The unique identifier is compared to a stored list of registered unique identifiers 104. If the judge is registered they will load all pre-set information associated with the particular judge, including event information 108. The system may prompt the judge to create an account if one does not currently exist 110. System will then retrieve account information related to the registered judge 112. Account information may include, but is not limited to, pre-set preferences for the judge, event information, event details, and other information relevant to the judge in relation to a sporting event. Account information is sent to the mobile electronic device and populated with the appropriate information 114.

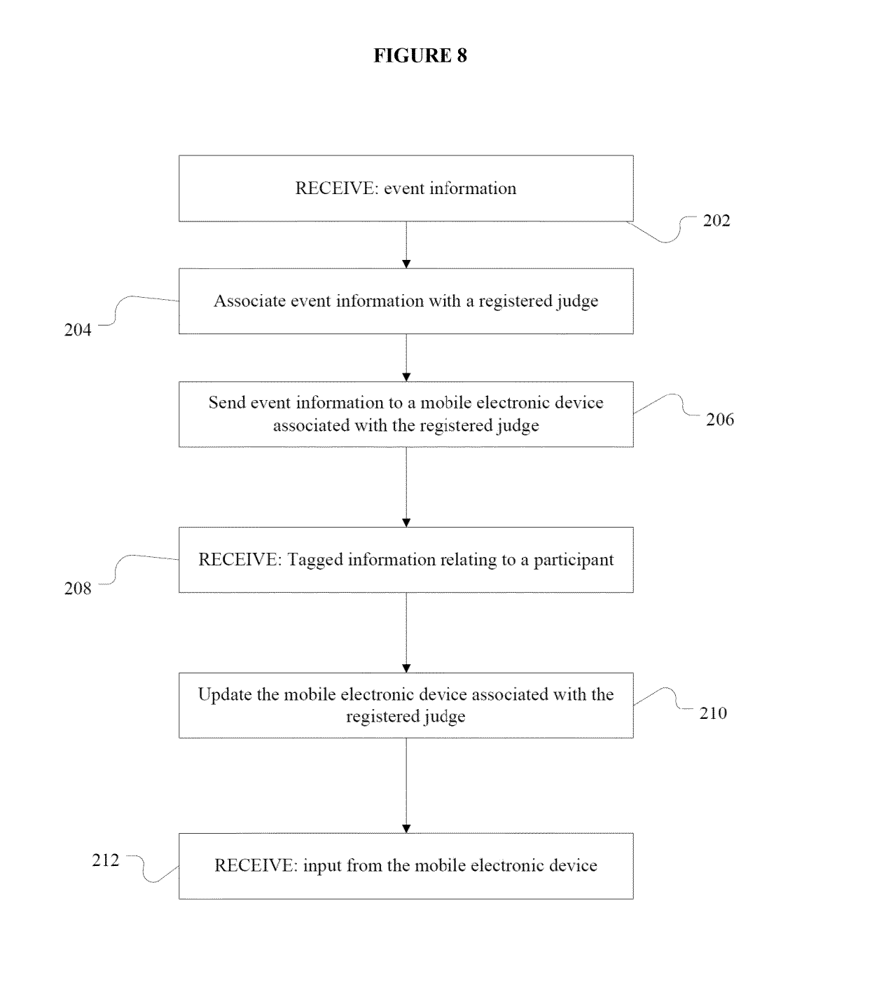

FIG. 8 illustrates a flowchart showing the method of transferring information across the computer based server during a particular event. The computer based server is adapted to receive event information through Office portal 202. The information is associated with one or more judges 204. Event information is sent to a mobile electronic device associated with the judge 206. The computer based server will then receive a variety of tagged information relating to a particular participant 208. For example, a participant may be tagged as “active” by Office personnel upon beginning their turn. Participant is then tagged as each jump, or even marking point, is achieved. The mobile electronic device is then automatically updated as each tagging point is reached 210. Judges can input information on the mobile electronic device that is updated in real time to the server 212. Information may include, but is not limited to, scoring, descriptions, comments, or other information relevant to a participant's performance.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program PIN embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device,

Program PIN embodied on a computer readable medium may be transmitted using any appropriate medium, including but not limited to wireless, wire-line, optical fiber cable, radio frequency, etc., or any suitable combination of the foregoing. Computer program PIN for carrying out operations for aspects of the present invention may be written in any combination of one or more programming languages, including an object oriented programming language such as Java, C#, C++ or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be preformed on the computer, other programmable apparatus or other devices to produce a computer implemented process such that the instructions which execute on the computer or other programmable apparatus provide processes for implementing the functions/acts specified in the flowchart and/or block diagram block or blocks.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A computer based system for tracking and judging an equestrian event, comprising:
a computer based server;
a mobile electronic device;
wherein the computer based server is operable to:
receive an event and corresponding event information;
associate the event with a registered judge;
receive a unique log in and PIN from the mobile electronic device;
determine whether the unique log in and PIN belongs to the registered judge;
associate the mobile electronic device with the registered judge based upon a determination the unique log in and PIN matches;
load the event and corresponding event information onto the mobile electronic device.

2. A computer based system for tracking and judging an equestrian event, comprising:
A computer based server operable to:
display on a mobile computing device event information, wherein the event information includes a list of registered participants;
create a tracking identity with a participant;
mark the tracking identity as active based upon receiving an indication the participant will begin competing;
update display on the mobile computing device to indicate the participant will begin competing;
receive one or more tracked locations as the participant reaches each tracked location;
update the mobile electronic device to indicate the one or more tracked locations;
receive input from the mobile electronic device, wherein the input relates to a score for each tracked location,
send the input to one or more spectator's electronic devices.
